(19) United States
(12) Patent Application Publication
(10) Pub. No.: US 2021/0023671 A1
(43) Pub. Date: Jan. 28, 2021

(54) TURRET SPINDLE LOCKING FIXTURE

(71) Applicant: S&S Cycle Inc., Viola, WI (US)

(72) Inventor: Paul R. Turgasen, Richland Center, WI (US)

(21) Appl. No.: 16/519,441

(22) Filed: Jul. 23, 2019

(51) Int. Cl. B23Q 16/04

(52) U.S. Cl. CPC B23Q 16/04

(57) ABSTRACT

A turret spindle locking fixture has a base, a flange extending radially inward from the base, and at least one locking structure extending from the flange or the base and adapted to engage a turret spindle. The turret spindle locking fixture is hands-free in that once the fixture is placed on a turret spindle, a user does not need to continue holding the fixture to lock the spindle.

### FIELD

The disclosure relates, generally, to the field of live tooling. More particularly, the disclosure relates to a fixture to lock a turret spindle during removal/replacement of live tools in a live tooling computer numerical control (“CNC”) machine.

### BACKGROUND

CNC machines are generally used to cut a component out of a larger piece of material. In addition, live tooling CNC machines allow for secondary features to be machined on the component both around the edge and on surfaces of the component using, for example, drilling and tapping.

The live tools of a live tooling CNC machine can be changed out. Generally, the live tools are secured in a spindle. In order to remove a live tool or insert a new live tool, the spindle must be held in place to prevent the spindle from rotating. Generally, live CNC machines include a two-part tool including a spanner wrench to lock the spindle in place and a second wrench to unlock the live tool. While live CNC machines provide the two-part tool, the two-part tool can be difficult to use because the two-part tool occupies both hands of an operator, thereby making it difficult for the operator to exert the required force to unlock the live tool and pull the live tool from the spindle, if necessary. Furthermore, different factors, such as configuration of the CNC machine, location of the CNC machine, etc., will affect an operator's ability to access the spindle, as well as the gain clearance around the spindle.

Therefore, a need exists to overcome the above stated, and other, deficiencies of existing devices used to unlock live tooling from live tooling CNC machines.

### SUMMARY OF THE DISCLOSURE

To overcome the aforementioned, and other, deficiencies, the present disclosure provides a turret spindle locking fixture.

In accordance with embodiments of the present disclosure, a turret spindle locking fixture comprises a base, a flange extending radially inward from the base, and at least one locking structure extending from the flange or the base and adapted to engage a turret spindle.

In accordance with further embodiments of the present disclosure, a method of removing a living tool from a CNC machine comprises securing a turret spindle locking fixture to a turret spindle including a living tool, causing at least one locking structure of the turret spindle locking fixture to engage a corresponding structure on the turret spindle, thereby preventing rotation of the turret spindle, without a user holding the turret spindle locking fixture in position, and removing the living tool from the turret spindle using a second device while the turret spindle locking fixture is secured to the turret spindle.

In accordance with embodiments of the present disclosure, a turret spindle locking fixture comprises a U-shaped base, a U-shaped flange extending radially inward from an upper surface of the U-shaped base, and at least one locking structure extending from an inner surface of the U-shaped flange or the U-shaped base and adapted to engage a corresponding structure of a turret spindle.

The foregoing and other features and advantages of the disclosure will be apparent from the following more particular description of embodiments of the disclosure. It is to be understood that both the foregoing general description and the following detailed description are exemplary, but are not restrictive, of the disclosure.

### BRIEF DESCRIPTION OF THE DRAWINGS

The features of the present disclosure will best be understood from a detailed description of the disclosure and an embodiment thereof selected for the purposes of illustration and shown in the accompanying drawings in which:

FIG. 1 is a top view of a turret spindle locking fixture in accordance with an embodiment of the present disclosure;

FIG. 2 is bottom view of the turret spindle locking fixture of FIG. 1 in accordance with an embodiment of the present disclosure;

FIG. 3 illustrates an exemplary spindle with which the turret spindle locking fixture may be used, in accordance with an embodiment of the present disclosure; and

FIG. 4 shows the turret spindle locking fixture of FIG. 1 in use on the exemplary spindle of FIG. 3, in accordance with an embodiment of the present disclosure.

### DETAILED DESCRIPTION OF THE PREFERRED EMBODIMENT

Although certain preferred embodiments of the present disclosure will be shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of an embodiment. The features and advantages of the present disclosure are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

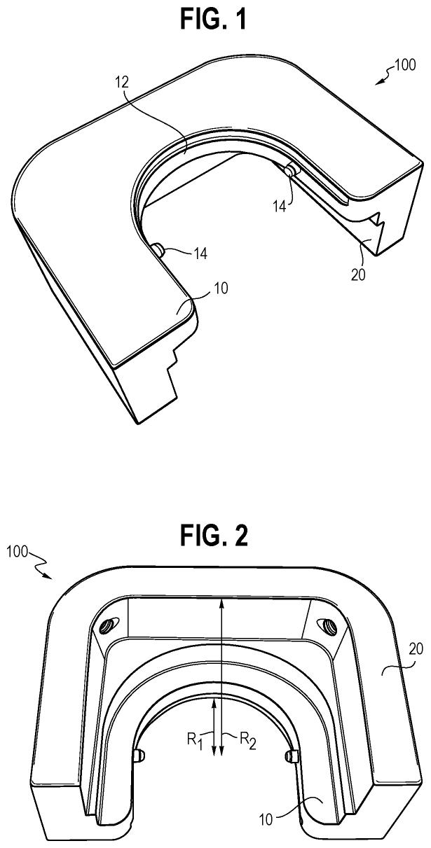

FIGS. 1 and 2 illustrate a turret spindle locking fixture 100 in accordance with embodiments of the present disclosure, with a top view of the turret spindle locking fixture 100 shown in FIG. 1 and a bottom view of the turret spindle locking fixture 100 shown in FIG. 2. The turret spindle locking fixture 100 can include a U-shaped flange 10 coupled to and extending radially inward from a U-shaped base 20. As a result, the turret spindle locking fixture 100 can have a cross-section having a generally L-shape. Preferably, the turret spindle locking fixture 100 can have a generally L-shaped cross-section along the entire U-shape of the turret spindle locking fixture 100. While the U-shaped flange 10 and the U-shaped base 20 are described herein as U-shaped, other shapes are envisioned, such as a straight line, an L-shape, and a toroid.

The U-shaped flange 10 can have an inner surface 12 including at least one locking structure 14. Preferably, and in the embodiment shown in FIGS. 1 and 2, the inner surface 12 can include two locking structures 14. The locking structures 14 shown in FIGS. 1 and 2 can be locking pins or other fixed protrusions. That is, the locking structures 14 are adapted to engage a corresponding feature (e.g. a detent or groove) of the turret spindle. When the locking structures 14 physically contact the turret spindle, the locking structures 14 will interact with the corresponding structure of the turret spindle to secure the turret spindle locking fixture 100 in place around the turret spindle and prevent the turret spindle from rotating. The locking structures 14 extend perpendicularly from the inner surface 12.

As will be appreciated, the specific design of the locking structures 14 may vary based on the particular machine that the turret spindle locking fixture 100 engages. Other exemplary locking structures include, but are not limited to, any structures having a corresponding mating structure on the turret spindle (e.g., protuberances, recesses, teeth, continually increasing radius, etc.) and other mechanical buttons.

The U-shaped base 20 and U-shaped flange 10 can each have an approximate radius R₂ and R₁, respectively. Radius R₁ of the U-shaped flange 10 can be slightly larger than a radius of the turret spindle so that the turret spindle locking fixture 100 can be easily positioned around at least a portion of the turret spindle, while still causing the locking structures 14 to engage the turret spindle. In the embodiment shown, radius R₂ can be larger than radius R₁ to fit around contouring of a turret spindle. However, in another embodiment, a difference between radius R₁ and radius R₂ may be smaller depending on the machine with which the turret spindle locking fixture 100 will be used.

Importantly, the turret spindle locking fixture 100 can omit a handle extending outward from the turret spindle locking fixture 100. Instead, a user can manipulate the turret spindle locking fixture 100 by grasping the U-shaped base 20.

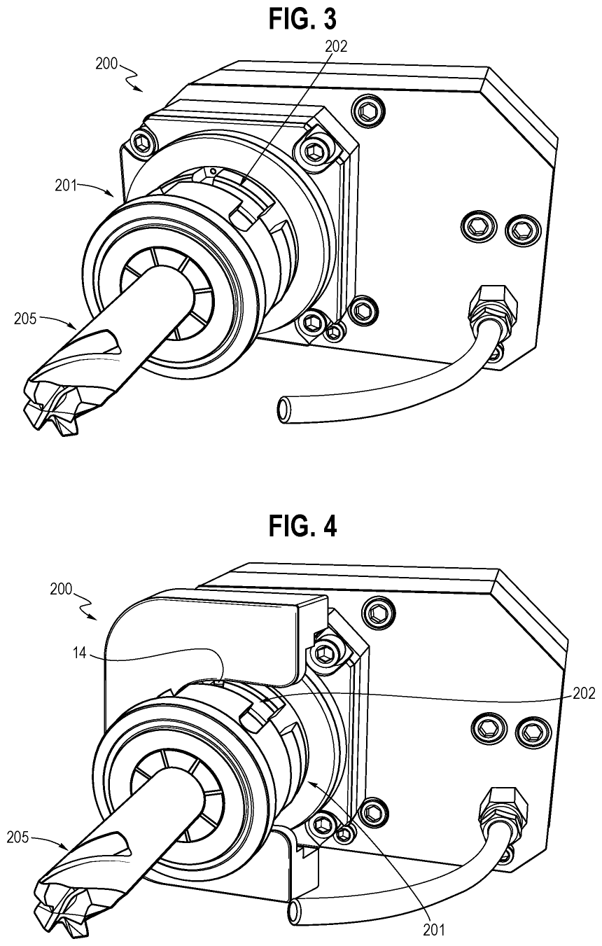

FIG. 3 illustrates an exemplary turret spindle 200. As shown in FIG. 3, the turret spindle 200 includes a spindle base 201, which includes at least one locking device which corresponds to the at least one locking structure 14 of the turret spindle locking fixture 100. In the specific embodiment shown, the spindle base 201 contains two grooves 202 (only one shown) that engage the locking structures 14 of the turret spindle locking fixture 100. The turret spindle 200 also includes a living tool 205, which in the embodiment shown is a bit, secured in the turret spindle 200.

FIG. 4 shows the turret spindle locking fixture 100 positioned on and engaging the turret spindle 200. Being generally U-shaped, the turret spindle locking fixture 100 may not completely encircle the spindle base 201, but rather can extend around a portion or majority of the spindle base 201. The locking structures 14 can engage with and extend into the grooves 202.

Importantly, the turret spindle locking fixture 100 can secure to the spindle base 201 without a user needing to continually hold the turret spindle locking fixture 100 in position. The turret spindle locking fixture 100 is, essentially, a hands-free fixture as it prevents the turret spindle 200 from spinning without requiring a user to hold the turret spindle locking fixture 100 in place. Because the turret spindle locking fixture 100 is a hands-free fixture, a user can use both hands to remove the living tool 205 from the turret spindle 200.

The turret spindle locking fixture 100 can comprise a metal or metal-based material, a plastic or plastic-based material, or a fiber-reinforced material. Preferably, and in the embodiment shown, the turret spindle locking fixture 100 comprises a metal or metal-based material. Further, in an embodiment, the turret spindle locking fixture 100 can comprise a single molded structure with the locking structures 14 being integrated separately into the U-shaped flange 10 depending on the design of the locking structures 14; however, in further embodiments, the U-shaped flange 10 and U-shaped base 20 can be separately manufactured components and secured to one another through any suitable method known in the art.

The turret spindle locking fixture 100 can have a color which contrasts with the turret spindle 200 to serve as a visual indicator that the turret spindle 200 is locked. This is important to prevent turning on the machine while the turret spindle locking fixture 100 is still in place. Preferably, the turret spindle locking fixture 100 is brightly colored at least on the outer surface of the U-shaped flange 10 and/or the outer surface of the U-shaped base 20. Exemplary suitable colors include, but are not limited to, red, pink, orange, yellow and green.

Also disclosed herein is a method of removing (and, optionally, replacing) a living tool from a CNC machine. The method includes first securing a turret spindle locking fixture, such as one in accordance with any one or more embodiments described herein, to a turret spindle containing a living tool. The user does not hold the turret spindle locking fixture in position because the turret spindle supports the turret spindle locking fixture. In an embodiment, the step of securing the turret spindle locking fixture to the turret spindle comprising placing the turret spindle locking fixture around a portion of the turret spindle such the at least one locking structure physically contacts and engages corresponding structure or devices of the turret spindle. The step of securing the turret spindle locking fixture to the turret spindle may further include engaging the at least one locking structure with a corresponding at least one structure on the turret spindle.

The method further includes removing the living tool using a second device. Because a user does not need to hold the turret spindle locking fixture in place, the user has two hands available to remove the living tool. Generally, a wrench is used to remove the living tool. If the living tool is being replaced, the new tool is then secured in the turret spindle. The turret spindle locking fixture is then removed from the turret spindle prior to using the machine.

The foregoing description has been presented for purposes of illustration and description. It is not intended to be exhaustive or to limit the disclosure to the precise form disclosed or to the materials in which the form may be embodied, and many modifications and variations are possible in light of the above teaching.

It is specifically intended that the present disclosure not be limited to the embodiments and illustrations contained herein, but include modified forms of those embodiments including portions of the embodiments and combinations of elements of different embodiments as come within the scope of the following claims.

What is claimed is:

1. A turret spindle locking fixture comprising:
a base;
a flange extending radially inward from the base; and
at least one locking structure extending from the flange or the base and adapted to engage a turret spindle.

2. The turret spindle locking fixture of claim 1, wherein the base is U-shaped, and wherein the flange is U-shaped.

3. The turret spindle locking fixture of claim 1, wherein the at least one locking structure extends outwardly from an inner surface of the flange.

4. The turret spindle locking fixture of claim 1, wherein the base has a radius adapted to fit around a turret spindle.

5. The turret spindle locking fixture of claim 1, wherein the flange has a radius adapted to fit around a turret spindle such that the at least one locking structure physically contacts the turret spindle.

6. The turret spindle locking fixture of claim 5, wherein the at least one locking structure is adapted to engage a corresponding structure on a turret spindle.

7. The turret spindle locking fixture of claim 6, wherein the corresponding structure is a groove of the turret spindle.

8. The turret spindle locking fixture of claim 1, wherein the turret spindle locking fixture is handless.

9. The turret spindle locking fixture of claim 1, wherein the turret spindle locking fixture is adapted to secure to a turret spindle and prevent rotation of the turret spindle without being held in position by a user.

10. The turret spindle locking fixture of claim 2, including at least two locking structures positioned on opposite sides of the U-shaped base.

11. The turret spindle locking fixture of claim 1, wherein the turret spindle locking fixture comprises a metal or metal-based material.

12. The turret spindle locking fixture of claim 1, wherein the base has an outer surface and the flange has an outer surface, wherein the turret spindle comprises a first color, and wherein at least one of the outer surface of the base and the outer surface of the flange comprises a second color different from the first color.

13. The turret spindle locking fixture of claim 12, wherein both the outer surface of the base and the outer surface of the flange comprise the second color.

14. The turret spindle locking fixture of claim 1, wherein the flange and the base together have an L-shaped cross-section.

15. A method of removing a living tool from a machine comprising:
securing a turret spindle locking fixture to a turret spindle including a living tool;
causing at least one locking structure of the turret spindle locking fixture to engage a corresponding structure on the turret spindle, thereby preventing rotation of the turret spindle, without a user holding the turret spindle locking fixture in position; and
removing the living tool from the turret spindle using a second device while the turret spindle locking fixture is secured to the turret spindle.

16. The method of claim 15, wherein the step of securing the turret spindle locking fixture to a turret spindle comprises placing the turret spindle locking fixture around a portion of the turret spindle such the at least one locking structure physically contacts the corresponding structure of the turret spindle.

17. The method of claim 15, wherein the step of securing the turret spindle locking fixture to the turret spindle further includes engaging the at least one locking structure with a corresponding at least one structure on the turret spindle.

18. The method of claim 15, wherein the corresponding locking feature is a groove, and wherein causing the causing the at least one locking structure of the turret spindle locking fixture to engage the corresponding structure on the turret spindle comprises causing the at least one locking structure of the turret spindle locking fixture to engage the groove.

19. The method of claim 15 further comprising the turret spindle completely supporting the turret spindle locking fixture after the locking structure of the turret spindle locking fixture engages the corresponding structure on the turret spindle.

20. A turret spindle locking fixture comprising:
a U-shaped base;
a U-shaped flange extending radially inward from an upper surface of the U-shaped base; and
at least one locking structure extending from an inner surface of the U-shaped flange or the U-shaped base and adapted to engage a corresponding structure of a turret spindle.
